(19) United States
(12) Patent Application Publication
(10) Pub. No.: US 2006/0207702 A1
(43) Pub. Date: Sep. 21, 2006

(54) Pneumatic tire

(75) Inventor: Tetsuji Miyazaki, Osaka-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: Toyo Tire & Rubber Co., Ltd., Osaka-shi (JP)

(21) Appl. No.: 11/374,847

(22) Filed: Mar. 14, 2006

(30) Foreign Application Priority Data
Mar. 17, 2005 (JP) 2005-078104

(51) Int. Cl. B60C 11/12

(52) U.S. Cl. 152/209.18; 152/DIG. 3

(57) ABSTRACT

A pneumatic tire with improved performance on snowy and icy roads which inhibits uneven tread wear. The pneumatic tire includes main grooves extending in a tire circumferential direction and transverse grooves connecting said main grooves formed on a tread, with blocks formed by said main grooves and said transverse grooves, said blocks provided with wave-shaped sipes, wherein the amplitude of at least one of wave-shaped sipes in a block outermost portion is smaller than the maximum value of amplitude of wave-shaped sipes in the same blocks.

The description of this application claims benefit of priority based on Japanese Patent Application No. 2005-078104, the entire same contents of which are incorporated by reference herein.

### BACKGROUND OF THE INVENTION

1. Field of the Invention

The present invention relates to a pneumatic tire. More specifically, the present invention relates to a pneumatic tire provided with blocks with wave-shaped sipes formed, wherein both icy and snowy road performance and uneven wear resistance are achieved.

2. Description of the Prior Art

In a pneumatic tire provided with blocks for running on icy and snowy roads, many sipes are formed on blocks, thereby generating edge effects. As a result, drainage has been improved, and further, braking performance, cornering performance, and cornering performance on icy and snowy roads have been improved.

In a pneumatic tire disclosed in Japanese Patent Application Laid-open No. H9-142110 (FIG. 1), wave-shaped sipes are formed in a tire width direction. Generally, compared with straight line sipes, wave-shaped sipes show higher edge effects. As a result, braking performance, cornering performance, and cornering performance on icy and snowy roads and the like have been improved.

However, when wave-shaped sipes are formed, compared with when straight line sipes are formed, rigidity of blocks is degraded. For this reason, peripheral portions of blocks which originally have low rigidity have even lower rigidity, causing blocks to wear. As a result, uneven wear is liable to occur in blocks. In particular, when running on dry roads with winter tires having relatively soft tread rubbers, uneven wear is likely to occur.

On the other hand, in order to prevent uneven wear, some times, wave-shaped sipes in which a crest section and a trough section thereof are inflecting in a depth direction of sipes are employed. Such sipes are effective for enhancing rigidity of blocks and improving edge effect, however, when used too much, resistance in drawing blades becomes large and it leaves a problem that sipes may be damaged at the time of mold release.

Therefore, the object of the present invention is to improve performance on snowy and icy roads, while inhibiting uneven wear.

As a result of intensive studies for solving the above problems, the inventor has arranged the invention as recited in Claim 1 to be a pneumatic tire with main grooves extending in tire circumferential direction and transverse grooves connecting said main grooves formed on a tread, with blocks formed by said main grooves and said transverse grooves, said blocks provided with wave-shaped sipes, wherein amplitude of at least one of wave-shaped sipes in a block outermost portion is smaller than the maximum value of amplitude of wave-shaped sipes in the same blocks.

As mentioned above, by forming wave-shaped sipes, higher edge effects are achieved compared with when straight line sipes are formed. As a result, braking performance, traction performance, and cornering performance on icy and snowy roads and the like can be improved. Further, since amplitude of some wave-shaped sipes in the outermost portion of a block is set to be smaller than the maximum value of amplitude of wave-shaped sipes in the outermost part of a block, rigidity of blocks in peripheral portions which is likely to wear are improved, thereby capable of inhibiting uneven wear.

The inventor has arranged the invention as recited in Claim 2 to be a pneumatic tire as set forth in Claim 1, wherein amplitude of wave-shaped sipes are formed in on a block central portion is largest and the amplitude of wave-shaped sipes gradually decreases toward a block peripheral portions.

Further, since amplitude of sipes is gradually decreased from central portions to outermost portions, uneven wear can furthermore be inhibited.

The inventor has arranged the invention as recited in Claim 3 to be a pneumatic tire as set forth in Claim 1, wherein wave-shaped sipes with small amplitude and sipes with large amplitude are alternately formed in.

Since wave-shaped sipes with large amplitude are not consecutively arranged, decrease in rigidity of central portions of blocks can be prevented and further, uneven wear can be inhibited.

The inventor has arranged the invention as recited in Claim 4 to be a pneumatic tire as set forth in Claim 1, wherein the outermost wave-shaped sipes with smaller amplitude than the maximum value of amplitude of wave-shaped sipes in the same block are located on a trailing edge of a block.

Generally, compared with leading edge of blocks, trailing edge of blocks are more likely to wear. Therefore, in pneumatic tires in which a tire rotational direction is fixed, amplitude of only the outermost sipes present in trailing edge of blocks may be narrowed.

The inventor has arranged the invention as recited in Claim 5 to be a pneumatic tire as set forth in Claim 1, wherein the outermost wave-shaped sipes with smaller amplitude than the maximum value of amplitude of wave-shaped sipes are the sipes whose crest section and trough section of a wave-shaped inflect in the sipe depth direction.

When crest section and trough section of a wave-shaped inflect in a sipe depth direction, rigidity of peripheral portions of blocks is enhanced, thereby inhibiting generation of uneven wear.

The inventor has arranged the invention as recited in Claim 6 to be a pneumatic tire as set forth in Claim 1, wherein amplitude of the outermost wave-shaped sipes is 0.5 times to 0.87 times as large as the maximum value of amplitude of wave-shaped sipes in the same block.

When amplitude of the outermost wave-shaped sipes is less than 0.5 times as large as the maximum value of amplitude of wave-shaped sipes in the same block, amplitude of other sipes gets large. Thus, overall rigidity of blocks gets lower and satisfactory edge effect may not be obtained. On the other hand, when amplitude of the outermost wave-shaped sipes exceeds 0.87 times, difference from amplitude of other wave-shaped sipes gets small and the effect of inhibiting uneven wear may not be satisfactory.

According to the present invention, amplitude of wave-shaped sipes in a block outermost portion is smaller than the maximum value of amplitude of wave-shaped sipes in the same blocks, which minimizes the decrease in rigidity in the block peripheral portion. As a result, tire performance can be secured without damaging high edge effect by wave-shaped sipes, thereby inhibiting uneven wear.

### BRIEF DESCRIPTION OF THE DRAWINGS

FIG. 1a is a schematic view showing tread patterns of a pneumatic tire pertaining to the present invention.

FIG. 1b is an enlarged view illustrating one of the blocks.

FIG. 1c is an enlarged view illustrating one of the blocks.

FIG. 2 is a schematic view illustrating sipes.

### DESCRIPTIONS OF THE PREFERRED EMBODIMENTS

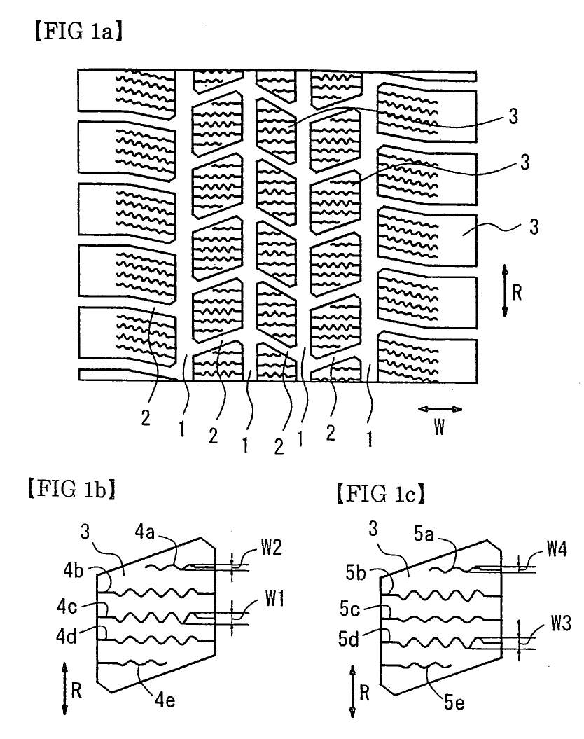

Embodiment of the pneumatic tire according to the present invention will now be explained by use of the drawings. FIG. 1 is a schematic view illustrating a tread pattern of the pneumatic tire according to the present invention. In FIG. 1a, reference number 1 are main grooves extending in a tire circumferential direction R, and reference number 2 are transverse grooves connecting main grooves 1. Block 3 are formed by main grooves 1 and transverse grooves 2 and therefore the tire has block patterns. In block 3, wave-shaped sipes are formed extending in a tire width direction W.

FIG. 1b is an enlarged view showing one of block 3. Wave-shaped sipes 4a, 4b, 4c, 4d, and 4e are arranged in circumferential direction R. Amplitude W1 of sipe 4c which is formed on a central portion of block 3 is the largest. Amplitude of the outermost sipes 4a and 4e is W2 which is smaller than W1. And amplitude of wave-shaped sipes gradually decreases from centeral portions to outermost portions. Here, outermost sipes mean sipes positioned on both ends in the direction where plural of sipes are arranged.

As sipes 4a to 4e are wave-shaped sipes, compared with straight line sipes, larger edge effect is shown. As a result, on snowy and icy roads, braking performance and traction performance are improved. On the other hand, since amplitude of the outermost sipes 4a and 4e are small, rigidity of peripheral portions of block 3 is enhanced. As a result, uneven wear in block 3 is inhibited. In addition, since amplitude of sipes is gradually decreased from central portions to outermost portions, uneven wear can furthermore be inhibited.

As shown in FIG. 1c, wave-shaped sipes 5b and 5d with large amplitude and wave-shaped sipes 5a, 5c, and 5e with small amplitude may alternately be arranged. In other words, since amplitude of sipes 5a and 5e is set to be small, uneven wear as mentioned above can be inhibited. In addition, since wave-shaped sipes with large amplitude are not arranged consecutively, decrease in rigidity of central portions of block 3 can be prevented, thereby further capable of inhibiting uneven wear.

For information, amplitude of wave-shaped sipes refers to a height of vertexes of adjacent waves as shown in FIGS. 1b and c. Further, wave-shaped sipe includes a zigzag-shaped sipe.

In a pneumatic tire with fixed rotational directions of a tire, a trailing edge is liable to wear. Therefore, amplitude of outermost sipes present in a trailing edge of blocks alone may be decreased.

Likewise, wave-shaped sipes extending in a tire circumferential direction R may be arranged in a tire width direction. In this case, sipes on both sides in a tire width direction W are the outermost sipes. As mentioned above, by narrowing amplitude of outermost sipes, uneven wear of block peripheral portions on both sides of a tire width direction W.

In FIGS. 1b and c, although wave-shaped sipes 4a have shapes in which straight line portions are connected to both sides of wave-shaped portions, other shapes may be employed. For example, sipes may be composed of wave-shaped portions alone. In any case, both sides of sipes may be either of open or closed.

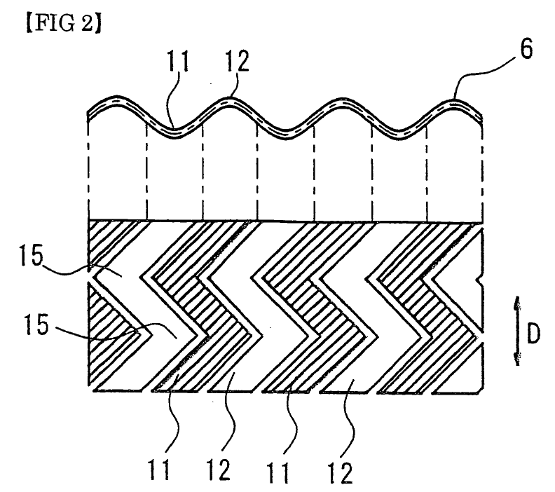

Further, wave-shaped sipes may be formed in wave-shaped sipes in which crest portions and trough portions of wave-shaped sipes shown in FIG. 2 deflect in sipe depth directions. FIG. 2 is a sectional view of wave-shaped portion 6 of a sipe in a depth direction D. Crest portions 12 and trough portions 11 of wave-shapeds have deflection portions 15 as they go into a depth direction D. Deflection portions 15 enhance rigidity of block peripheral portions thereby inhibiting the generation of uneven wear. Here, the number of deflection portions 15 may be one or more.

Amplitudes W2 and W4 of outermost sipes are preferably 0.5 times to 0.87 times as large as maximum amplitudes W1 and W4, respectively. When they (W2 and W4) are less than 0.5 times, amplitude of other sipes get large, causing overall block rigidity to lower and therefore, satisfactory edge effect may not be obtained. On the other hand, when they (W2 and W4) exceed 0.87 times, effect of inhibiting uneven wear may be lowered.

### EXAMPLES

As Examples, samples of pneumatic tires pertaining to the present invention and those to the Comparative Examples were manufactured respectively and performance thereof was evaluated. Tires pertaining to all the Examples and Comparative Examples have patterns as shown in FIG. 1(a), but blocks of tires pertaining to Examples are provided with wave-shaped sipes shown in FIG. 1(b). Further, in Example 2, outermost sipes on both sides in block circumferential direction R deflect in a depth direction as shown in Example 2. On the other hand, in tires pertaining to Comparative Examples, amplitude of wave-shaped sipes is constant, the value of which is shown in Table 1.

Performance was evaluated by mounting tires with tire size of 195/65 R15 91T and with air pressure of 200 kPa on a four-wheel-drive vehicle with 2000 cc engine.

In Table 1, performance on snowy and icy roads was evaluated based on a driver's feeling driving on a snowy road surface and the evaluation is represented in indices with the value of Comparative 1 set to 100. Therefore, the larger numbers show better performance. Amount of uneven wear is that in a block after running 12000 km on a dried general road.

TABLE 1

| | Example | Example | Example | Example | Comparative | Comparative |
|---|---|---|---|---|---|---|
| | 1 | 2 | 3 | 4 | Example 1 | Example 2 |
| Amplitude of | 3 | 3 | 3 | 3 | 2 | 3 |
| central | | | | | | |
| portion sipe | | | | | | |
| W1 (mm) | | | | | | |
| Amplitude of | 2 | 2 | 1.5 | 2.6 | 2 | 3 |
| outermost | | | | | | |
| sipe W2 (mm) | | | | | | |
| Deflection | No | Yes | No | No | No | No |
| in depth | | | | | | |
| direction | | | | | | |
| Performance | 120 | 118 | 115 | 121 | 100 | 123 |
| on snowy and | | | | | | |
| icy roads | | | | | | |
| Amount of | 0.1˜1.2 | 0.8˜1.1 | 0.9˜1.2 | 1.2˜1.4 | 0.7˜1.1 | 1.4˜1.7 |
| uneven wear (mm) | | | | | | |

According to Table 1, in tires pertaining to Examples, it was found that performance on snowy and icy roads is improved without damaging uneven wear resistance. In other words, by making amplitude W2 of outermost sipes 0.5 to 0.87 times as large as maximum amplitude W1, both performance on snowy and icy roads and uneven wear resistance are achieved. On the other hand, as in Comparative Example 2, since every amplitude of sipes is set to be the same, uneven wear resistance is degraded.

1. A pneumatic tire with main grooves extending in tire circumferential direction and transverse grooves connecting said main grooves formed on a tread, with a plurality of blocks formed by said main grooves and said transverse grooves, said blocks provided with wave-shaped sipes, wherein an amplitude of at least one of the wave-shaped sipes in a block outermost portion is smaller than a maximum value of amplitude of the wave-shaped sipes in the same blocks.

2. A pneumatic tire as set forth in claim 1, wherein the amplitude of the wave-shaped sipes formed in a block central portion is largest and the amplitude of wave-shaped sipes gradually decreases toward periphery portions of said blocks.

3. A pneumatic tire as set forth in claim 1, wherein wave-shaped sipes with small amplitude and sipes with large amplitude are alternately formed.

4. A pneumatic tire as set forth in claim 1, wherein the outermost wave-shaped sipes with smaller amplitude than the maximum value of amplitude of wave-shaped sipes in the same block are located on a trailing edge of a block.

5. A pneumatic tire as set forth in claim 1, wherein the outermost wave-shaped sipes with smaller amplitude than the maximum value of amplitude of wave-shaped sipes are the sipes whose crest section and trough section of a wave-shaped sipe are inflection in the sipe depth direction.

6. A pneumatic tire as set forth in claim 1, wherein amplitude of the outermost wave-shaped sipes is 0.5 times to 0.87 times as large as the maximum value of amplitude of wave-shaped sipes in the same block.
